(19) United States
(12) Patent Application Publication
(10) Pub. No.: US 2008/0111354 A1
(43) Pub. Date: May 15, 2008

(54) Apparatus for guiding deployment of curtain airbag for vehicle

(76) Inventor: Seung Soo Ryu, Gunpo-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/652,279

(22) Filed: Jan. 10, 2007

(30) Foreign Application Priority Data
Nov. 10, 2006 (KR) 10-2006-0111288

(51) Int. Cl. B60R 21/21

(52) U.S. Cl. 280/730.2

(57) ABSTRACT

An apparatus for guiding deployment of a curtain airbag for a vehicle which is installed at an inside of the mating part where a head lining and a pillar trim of a center pillar meet with one another. The apparatus includes a guide member, one end of which is fixed to a vehicle body to which an airbag is mounted at a region below the curtain airbag and the other end of which is connected to an airbag cushion. The guide member may be a wire.

### CROSS-REFERENCE TO RELATED APPLICATION

This application claims priority to and the benefit of Korean Patent Application No. 10-2006-0111288 filed in the Korean Intellectual Property Office on Nov. 10, 2006, the entire contents of which are incorporated herein by reference.

### BACKGROUND OF THE INVENTION

(a) Field of the Invention

The present invention relates to an apparatus for guiding deployment of a curtain airbag for a vehicle, and more particularly to an apparatus for guiding deployment of a curtain airbag for a vehicle that reduces the possibility of the airbag cushion being caught by a pillar trim of a center pillar when a curtain airbag deploys.

(b) Description of the Related Art

Generally, a vehicle is provided with various safety devices for protecting a driver and occupants when a vehicle-crash occurs. An example of such safety devices includes an airbag. On type of airbag is installed in a steering wheel and a crash pad so as to explode and thus deploy when a front vehicle crash occurs, thereby protecting a driver and occupants. In addition, side airbags for absorbing side impact have been developed, and among side airbags, a curtain airbag is a device for protecting the head of a driver or an occupant.

Pillars which form a portion of a vehicle body are a metal structure forming a door frame and include a front pillar, a center pillar, and a rear pillar. A pillar trim is attached to an inside of pillars facing a cabin. In a conventional arrangement, the pillar trim of a center pillar may hinder deployment of a curtain airbag. For example, the curtain airbag may become stuck between the center pillar and the pillar trim when the curtain airbag deploys, so that the curtain airbag cannot normally operate.

In order to address this problem, a ramp formed as a bracket for preventing the curtain airbag from being caught and guiding deployment of the curtain airbag has been developed. However, the ramp bracket is typically made of metal and designed to have sufficient strength such that the ramp bracket is not deformed by expansion pressure. There is thus a problem that impact absorption is deteriorated. Furthermore, in a structure for deployment of the airbag cushion of the curtain airbag, since a portion where the head lining and the pillar trim contact one another is pushed with great pressure when the airbag cushion deploys, the pillar trim as well as the head lining may be separated, and this may cause injuries on occupants. Furthermore, since the ramp bracket is a separate part, assembling tolerance is increased and cost of material is increased.

### SUMMARY OF THE INVENTION

Embodiments of the present invention provide an apparatus for guiding deployment of a curtain airbag for a vehicle which is installed at an inside of a matching part where a head lining and a pillar trim of a center pillar meet with one another, one end of which is fixed to a vehicle body to which an airbag is mounted at a region below the curtain airbag and the other end of which is connected to an airbag cushion, so as to guide the airbag cushion in a normal direction when an airbag deploys, thereby preventing a curtain airbag from being caught by a center pillar.

An exemplary embodiment of the present invention provides an apparatus for guiding deployment of a curtain airbag for a vehicle which is installed at an inside of a matching part where a head lining and a pillar trim of a center pillar meet with one another, including a guide member one end of which is fixed to a vehicle body to which an airbag is mounted at a region below the curtain airbag and the other end of which is connected to an airbag cushion.

The guide member may be a wire which has length with which the guide member can be loosen to a lower end portion of the deployed airbag cushion and a center portion of which is temporarily bound.

A guide which is rounded toward a cabin may be formed at an upper end portion of the pillar trim such that a wire which is connected to a lower end portion of the airbag cushion can be guided in a normal direction when the airbag cushion deploys.

### BRIEF DESCRIPTION OF THE DRAWINGS

FIG. 1 is a side view showing an installed state of an apparatus for guiding deployment of a curtain airbag for a vehicle according to an exemplary embodiment of the present invention.

FIG. 2 is a side view showing an operating state of an apparatus for guiding deployment of a curtain airbag for a vehicle according to an exemplary embodiment of the present invention.

### DETAILED DESCRIPTION OF THE EMBODIMENTS

Exemplary embodiments of the present invention will hereinafter be described in detail with reference to the accompanying drawings.

According to an exemplary embodiment of the present invention, a guide member 10 in a type of a wire is provided so as to address the problem that an airbag cushion 7a is stuck between or is caught by a pillar trim 3 of a center pillar while a curtain airbag 7 deploys, thereby guiding the airbag cushion 7a to deploy in a normal direction, and accordingly, the curtain airbag 7 is not stuck between or is caught by the center pillar. A curtain airbag 7 for a vehicle has a predetermined expansion area. It is mounted to an upper inner portion where a head lining (not shown) and the pillar trim 3 of the center pillar meet so as to protect an occupant from an impact by side crash of a vehicle and to minimize injuries on an occupant.

An apparatus for guiding the airbag cushion 7a according to an exemplary embodiment of the invention, such that the airbag cushion 7a can smoothly deploy into a cabin when the airbag cushion 7a is expanded by external impact, is provided at a vehicle body panel below the curtain airbag 7. The guiding apparatus is operated by deploying force of the airbag cushion 7a. An end of the guiding apparatus is fixed to the vehicle body, which is typically an airbag mounting part, and the other end thereof is formed as the guide member 10. In an exemplary embodiment, guide member 10 is a wire connected to the airbag cushion 7a. Accordingly, in case that the airbag cushion 7a of the curtain airbag 7 deploys by a side crash of a vehicle, a wire 11 (which is the guide member 10) is extended toward a deployment direction of the airbag cushion 7a so as to guide the airbag cushion 7a to deploy in a normal direction.

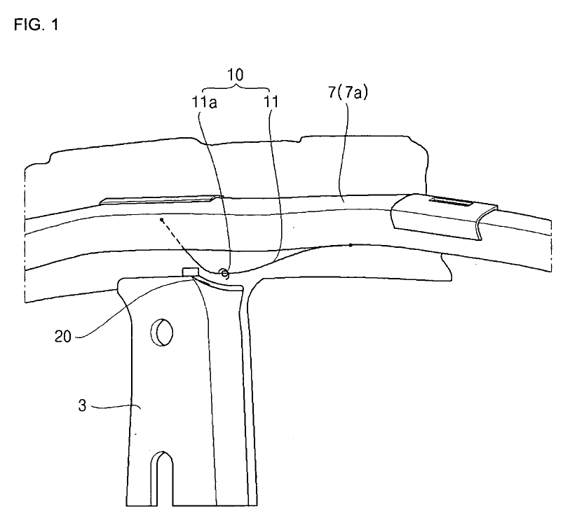

As shown in FIG. 1, since one end of the wire 11 is fixed to the vehicle body and the other end of the wire 11 is connected to the airbag cushion 7a as described above, the length of the wire 11 is determined in consideration of length after the airbag deploys such that the wire 11 may extend toward the deployment direction while the airbag cushion 7a deploys. That is, it is important to ensure sufficient length of the wire 11 before the airbag cushion 7a deploys so that the wire 11 can be extended from the vehicle body and to a lower portion of the airbag cushion 7a when the airbag cushion 7a completely deploys.

In addition, a center portion is bound such that the wire 11 does not hang down in a disorderly manner. Thus, wire 11 is temporarily bound such that the wire 11 can be easily freed when the airbag cushion 7a deploys.

A temporary binder 11a of the wire 11 is positioned at the pillar trim 3 of the center pillar, and it is configured to be hung on a mating part where the head lining (not shown) and the pillar trim 3 join together. A guide 20 which is rounded outward is formed at an upper end portion of the pillar trim 3 so that the wire 11 which is connected to a lower end of the airbag cushion 7a can be guided in a normal direction when the airbag cushion 7a explodes. In other words, guide 20 is an outwardly rounded, upper edge of pillar trim 3.

As such, the guide 20, which is rounded toward a cabin-side of the pillar trim 3, makes the wire 11, which is fixed to a lower end portion of the airbag cushion 7a, move toward a door glass while the airbag cushion 7a deploys. The airbag cushion 7a thus deploys normally, and in particular, the airbag cushion 7a, which is rounded outward and deploys, is guided toward an inside of the pillar trim 3 so as to be guided outward without being caught.

Operating states of an apparatus for guiding deployment of a curtain airbag for a vehicle according to an exemplary embodiment of the present invention will be explained hereinafter.

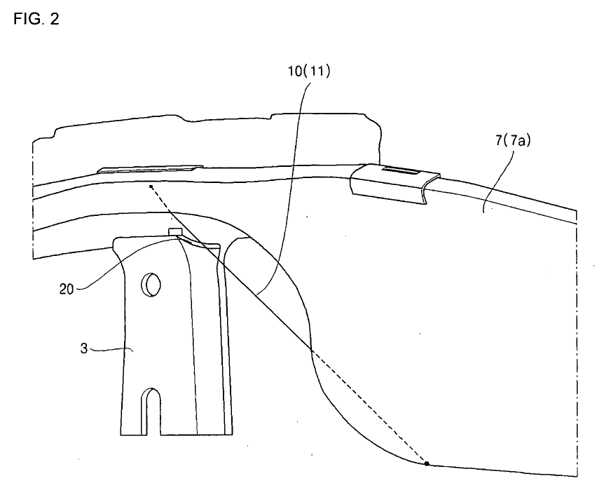

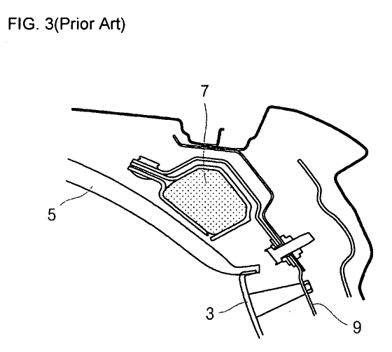

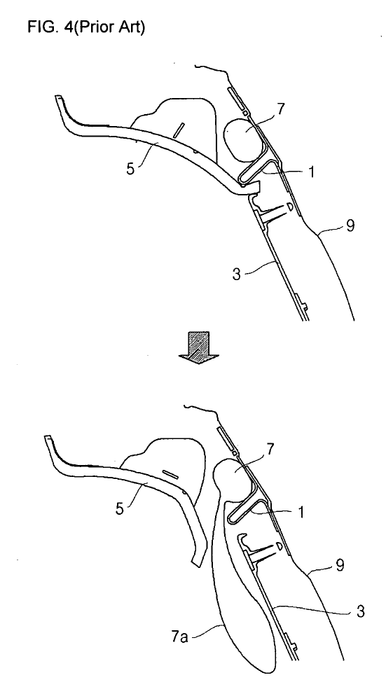

FIG. 2 is a drawing showing an operating state of an apparatus for guiding deployment of a curtain airbag for a vehicle according to an exemplary embodiment of the present invention.

If impact acts on a side of a vehicle when a side crash occurs, an airbag ECU receives a signal from an impact sensor (not shown), and then sends an operating signal to an inflator (not shown). When the airbag cushion 7a of the curtain airbag 7 is supplied with gas from the inflator so as to deploy, the airbag cushion 7a expands and thereby the wire 11 which is connected to the airbag cushion 7a is extended. At this time, while the temporary binder 11a (knot) of the wire 11 is removed, the wire 11 is extended by the guide 20 which is formed at the pillar trim 3 of the center pillar.

When the airbag cushion 7a is supplied with gas from the inflator so as to stat to deploy, the wire 11 one end of which is connected to a lower end of the airbag cushion 7a moves from a pre-deployment position of an airbag to an after-deployment position of an airbag, and at this time, while the wire 11 is extended by the guide 20 of the pillar trim 3, the wire 11 guides the airbag cushion 7a such that the airbag cushion 7a normally deploys toward a door glass, and at the same time, the curtain airbag 7 deploys into a cabin while opening the head lining (not shown) toward a cabin. Accordingly, when the airbag cushion 7a of the curtain airbag 7 expands, the airbag cushion 7a is guided to stably expand through a portion where the head lining (not shown) and the pillar trim 3 of the center pillar are matched with one another, thereby preventing the pillar trim 3 from being separated.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

As described above, according to an apparatus for guiding deployment of a curtain airbag for a vehicle according to according to an exemplary embodiment of the present invention, phenomenon that a curtain airbag is caught by a center pillar can be prevented, and a curtain airbag deploys in a normal direction, thereby preventing the pillar trim from being separated. Furthermore, since a wire is used as an apparatus for guiding deployment of a curtain airbag, cost can be reduced.

What is claimed is:

1. An apparatus for guiding deployment of a curtain airbag for a vehicle, which is installed at an inside of a mating part where a head lining and a pillar trim of a center pillar meet with one another, said apparatus comprising a guide member one end of which is fixed to a vehicle body to which an airbag is mounted at a region below the curtain airbag and the other end of which is connected to an airbag cushion.

2. The apparatus of claim 1, wherein the guide member is a wire having a length such that the guide member can be loosened at a lower end portion of the deployed airbag cushion with a center portion of which being temporarily bound.

3. The apparatus of claim 1, wherein a guide rounded toward a cabin is formed at an upper end portion of the pillar trim such that a wire connected to a lower end portion of the airbag cushion can be guided in a normal direction when the airbag cushion deploys.
